(19) United States
(12) Patent Application Publication
(10) Pub. No.: US 2006/0206328 A1
(43) Pub. Date: Sep. 14, 2006

(54) Voice-controlled audio and video devices

(76) Inventor: Klaus Lukas, Munchen (DE)

Correspondence Address: STAAS & HALSEY LLP, SUITE 700, 1201 NEW YORK AVENUE, N.W., WASHINGTON, DC, 20005, US

(21) Appl. No.: 10/568,818

(22) PCT Filed: Aug. 12, 2004
(86) PCT No.: PCT/EP04/51784

§ 371 Date: Feb. 21, 2006

(30) Foreign Application Priority Data
Aug. 18, 2003 (DE) 103 37 823.5

(51) Int. Cl. G10L 15/00

(52) U.S. Cl. 704/252

(57) ABSTRACT

Text information regarding audio and/or video data is assigned to phonemes by grapheme-to-phoneme conversion and used as the vocabulary of a speech recognition device.

### CROSS REFERENCE TO RELATED APPLICATIONS

This application is based on and hereby claims priority to PCT Application No. PCT/EP2004/051784 filed on Aug. 12, 2004 and German Application 10337823.5 filed on Aug. 18, 2003, the contents of which are hereby incorporated by reference.

### BACKGROUND OF THE INVENTION

Voice recognition in applications in the automotive field will be used increasingly in the future as a result of legislation and for the purpose of increased security. In addition to telephony applications, voice-controlled devices are now also used for telematics systems, infotainment systems and in-car systems such as air-conditioning systems. The vocabulary used is particularly easily structured by the current recognition device and is generally command-based.

The voice control of CD devices takes place in this case in current products by commands for the basic instructions such as stop, play, pause etc. The selection of the title to be played is entered by the number of the title, in other words by “play 5” for instance. In this case, the recognition device can be restricted to the recognition of the command word in conjunction with a digit. However this procedure is inconvenient as the user is often unaware of the assignment of the title to the number on the CD.

### SUMMARY OF THE INVENTION

Based on this, one possible the object of the invention is to make the operation of audio and video devices simpler, more user-friendly and safer.

Accordingly, in a method for voice recognition, multimedia data is stored on a storage medium. Text data is assigned to the multimedia data. The text data is assigned to phonemes as graphemes by grapheme-to-phoneme conversion. The text data with its associated phonemes can then be used as vocabulary for a voice recognition device.

This results in a significantly reduced recognition device vocabulary which is specific to the respective audio and/or video application, said recognition device vocabulary can also be processed by a voice recognition device with very few resources, as is usually the case with voice recognition solutions integrated in the car or in other video and/or audio devices.

This procedure allows a title to be entered directly, for example by “Play Waterloo” or only “Waterloo”, without the user additionally having to consider the correct title number while driving. Direct access is particularly desirable in audio systems with CD changers.

Multimedia data can include audio, video or image data. The storage medium can be an audio CD, a video CD, a DVD, an MP3 player, a hard disk video recorder, a hard disk, a photo CD, a floppy disc, a USB stick, a MiniDisc or any other permanently installed or changeable and/or portable storage medium.

According to one embodiment, the multimedia data is audio data and the storage medium is a CD.

Provided the CD comprises CD text, the text data assigned to the audio data is stored on the CD as CD text. This can then be used directly for the grapheme to phoneme conversion.

The multimedia data can be MP3 data for instance. The text data is then preferably stored in a playlist.

The text data assigned to the multimedia data can also generally be stored in a directory of the storage medium containing the multimedia data.

According to one embodiment, the multimedia data is video data. In this case, the storage medium can be a DVD for instance.

Alternatively or in addition the text data assigned to the multimedia data can be called up from a central database, in particular via the internet from an internet database.

The text data preferably contains the names of the artist/s and/or the title of the multimedia data to which it is assigned.

In particular, a multimedia device is controlled via the method with the aid of the voice recognition device. The multimedia device can be a CD player, an MP3 player, a CD changer, a MiniDisc player, a video recorder, a DVD player or a comparable device.

In a further step, the text data can be acoustically output via a text-to-voice conversion so that the user is read out his/her selection options, in particular relating to the title and artists.

A system which is set up to implement one of the illustrated methods can be implemented for example by programming and setting up a data processing system with units associated with the mentioned method.

The system can be a car radio for instance, in particular integrated with a navigation system, a CD player and/or a DVD player.

Further features and advantages of the invention result from the description of exemplary embodiments.

### DETAILED DESCRIPTION OF THE PREFERRED EMBODIMENT

Reference will now be made in detail to the preferred embodiments of the present invention.

In a method for voice recognition, a grapheme-to-phoneme technology is used in an integrated voice recognition device so that the title names of songs are converted into phoneme sequences and are used as recognition vocabulary for the voice-controlled use of CD, DVD and/or MP3 players. This allows the user to select the songs directly via title, artist or alternatively via the usual known number nomenclature.

If the positions assigned to the titles of different CDs produced as vocabulary are noted in the CD changer, the title can be recognized and assigned to a specific CD when the title is vocally entered. The changer can insert the desired CD and play the selected song. The size of the vocabulary in a 5-way changer with 20 songs per CD amounts accordingly to approximately 100 entries. This represents a vocabulary size which can be covered by integrated voice recognition devices with current technology.

As song titles can be present in different languages, a language identification should be carried out prior to converting the title into phoneme sequences, said language identification determines the suitable phoneme set and the correct language-specific conversion rules.

In the case of audio CDs, the song titles are present in text form on CD text-compatible CDs. As an alternative solution in networked motor vehicles, the title list can be made available for each download.

Text data from audio and/or video media is thus used as a vocabulary basis for the voice recognition device. The direct voice-controlled selection of song titles provides a convenient and less distracting method for operating CD and MP3 equipment in motor vehicles. The use of grapheme-to-phoneme technology allows this direct voice-controlled selection to be implemented and made available to the user within the scope of his/her voice-controlled user interface.

The illustrated method can be easily verified on the basis of its visibility on the user interface. The considerable increase in convenience allows the significant added value to be recognized by the user. As speaker-independent systems will also be implemented in the longer term in the automotive field, a vocal CD and/or DVD control is an ideal supplement.

The method can be used for instance directly for CDs in CD-text format. In addition to the actual music data, other additional data is stored on an audio CD, so-called “subchannels”. In this case there are 8 subchannels (p,q,r,s,t,u,v and w). The q-subchannel contains information for instance about the present position. A particular position is adopted by the lead-in area. The lead-in area is an area before the normal music data and contains, in the q-subchannels, the “Table of Contents” (TOC) of the CD, the directory of the CD for instance. The starting positions of the individual tracks are stored in the TOC. In the subchannels r-w of the lead-in, the CD-text information is stored, for instance the name of the CD, the name of the tracks and the artists.

This information allows a vocabulary to be dynamically generated for the voice recognition device. Thanks to grapheme-to-phoneme conversion, the text data can be converted into phoneme chains comprehensible to the recognition device. For operation purposes, the vocabulary or elements thereof can be used to control the audio and/or video device.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for voice recognition, comprising:
storing items of multimedia data on a storage medium;
assigning items of text data respectively to the items of multimedia data, the items of text data respectively having graphemes;
assigning the graphemes of the text data to respective phonemes; and
using the items of text data with phonemes assigned thereto as a vocabulary of a voice recognition device.

16. The method according to claim 15,
wherein the multimedia data is audio data and the storage medium is a CD.

17. The method according to claim 16,
wherein the text data assigned to the audio data is stored on the CD as CD text.

18. The method according to claim 15, wherein the multimedia data is MP3 audio data.

19. The method according to claim 18,
wherein the text data is stored in a playlist.

20. The method according to claim 15, wherein the multimedia data is video data.

21. The method according to claim 15, wherein the storage medium is a DVD.

22. The method according to claim 15, wherein the text data is stored in a directory on the storage medium.

23. The method according to claim 15, wherein the text data is obtained for the multimedia data from a central database.

24. The method according to claim 15, wherein the text data contains the name of the artists and/or the titles of the multimedia data to which it is assigned.

25. The method according to claim 15, further comprising controlling a multimedia device via the voice recognition device.

26. The method according to claim 15, wherein the text data is at least partially converted in a text-to-voice conversion and is output acoustically.

27. The method according to claim 15, wherein the text data is obtained for the multimedia data from a central database via the internet.

28. The method according to claim 27, wherein the text data contains the name of the artists and/or the titles of the multimedia data to which it is assigned.

29. The method according to claim 28, further comprising controlling a multimedia device via the voice recognition device.

30. The method according to claim 29, wherein the text data is at least partially converted in a text-to-voice conversion and is output acoustically.

31. A system which is set up to implement a method according claim 15.

32. The system according to claim 31, wherein the system is a car, a car radio, a CD player or a DVD player.

33. A system for voice recognition, comprising:
means for storing items of multimedia data on a storage medium;
means for assigning items of text data respectively to the items of multimedia data, the items of text data respectively having graphemes;
means for assigning the graphemes of the text data to respective phonemes; and
means for using the items of text data with phonemes assigned thereto as a vocabulary of a voice recognition device.
